(19) United States
(12) Patent Application Publication
(10) Pub. No.: US 2001/0051529 A1
(43) Pub. Date: Dec. 13, 2001

(54) Radio system and apparatus for, and method of , multicast communication

(75) Inventor: Robert J. Davies, Horley (GB)

Correspondence Address: Corporate Patent Counsel, U.S. Philips Corporation, 580 White Plains Road, Tarrytown, NY, 10591, US

(73) Assignee: Koninklijke Philips Electronics North America Corporation.

(21) Appl. No.: 09/861,940

(22) Filed: May 21, 2001

(30) Foreign Application Priority Data
May 23, 2000 (GB) 0012410.7

(51) Int. Cl. H04B 7/00

(52) U.S. Cl. 455/519; 455/518

(57) ABSTRACT

A multicast radio data communication system comprises a master and a plurality of slave stations, and uses a retransmission protocol. Data (10) is transmitted by the master station simultaneously to all slave stations. Each slave station acknowledges in turn in a respective time period (13 to 16) which may be assigned by the master station or pre-set. If the master receives a positive acknowledgement from each slave station, the master proceeds to transmit new data. If the master receives a negative acknowledgement from any slave station, or fails to successfully receive any acknowledgement from any slave station, the master station retransmits the previously transmitted data.

The invention relates to a radio system for, and method of, multicast data communication, and master and slave stations for use in a multicast radio network, and has particular, but not exclusive, application to the distribution of audiovisual data streams.

In point-to-point communication of digital information over a radio link it is common practice to divide the digital information into data packets and to employ error protection in the form of a retransmission protocol in which the receiving device transmits an acknowledgement for each data packet received. If a data packet is received correctly the acknowledgement is a positive acknowledgement (ACK), in which case the sending device proceeds to send the next data packet. If the data packet is received corrupted by errors the acknowledgement is a negative acknowledgement (NACK), in which case the sending device normally retransmits the data packet.

In multicast radio communication there is a single radio station, commonly referred to as a master station, sending data simultaneously to more than one receiving station, commonly referred to as slave stations. There are three basic alternative methods of operating such communication.

First, the digital information is broadcast to all slaves, and no acknowledgements are transmitted by the slaves. The disadvantage of this is that retransmissions cannot be requested when data packets are corrupted. This method is defined, for example, in the MPT1327 specification published by the UK Radiocommunications Agency, November 1991.

Second, the digital information is transmitted to each slave in turn, and each slave acknowledges receipt in turn. This method of operation is as a set of point-to-point communication links. The disadvantage of this is the cumulative time taken to serve all slaves, or the increased spectrum requirement if the data transmission rate is increased to offset the delay or if each link operates on a different frequency.

Third, the digital information is broadcast to all slaves and then each slave is interrogated in turn to determine whether the information has been received. The disadvantage of this is the cumulative time taken to interrogate all slaves. This method is also defined in the MPT1327 specification published by the UK Radiocommunications Agency, November 1991.

Time delay is a problem especially for time critical data such as audiovisual stream information. An example of an application of multicast radio communication for the transmission an audiovisual data stream is wireless loudspeakers. Wireless loudspeakers are desirable as a way to reduce cable installation. There is a requirement for different loudspeakers to receive different information, for example the left and right audio channels of a stereo pair, or several channels in a surround sound application.

The radio link from the master station to each wireless loudspeaker can be operated simultaneously as a set of point-to-point links. The disadvantage of this is that the master requires more bandwidth than a point-to-point link, and may require multiple radio transceivers. Furthermore, the different audio channels are typically available prior to transmission over the radio link as a single multichannel mix incorporating audio coding and compression, and sometimes joint coding of channels, as used in the MPEG joint stereo mode. It is desirable to transmit the different channels as a single stream multichannel mix in order to avoid the complexity of separating the different channels prior to transmission and to avoid the requirement to synchronise such separated channels received by different receiving devices.

An object of the invention is to provide improvements in multicast radio communication.

According to one aspect of the invention there is provided a method of operating a multicast radio system, comprising transmitting data from a master radio station simultaneously to a plurality of slave radio stations, transmitting from each of the plurality of slave radio stations, in response to receiving the data, an acknowledgement in a predetermined substantially non-overlapping time period, receiving each acknowledgement at the master station, and retransmitting the data from the master radio station if it fails to receive a positive acknowledgement from each of the plurality of slave stations.

According to a second aspect of the invention there is provided a multicast radio system comprising a master station and a plurality of slave stations, the master station comprising means to transmit data simultaneously to the plurality of slave stations, each of the plurality of slave stations having means to transmit an acknowledgement in response to receiving the data, wherein each acknowledgement is transmitted in a predetermined one of a plurality of substantially non-overlapping time periods, and the master station further comprising means to receive the acknowledgements and means to retransmit the data if it fails to receive a positive acknowledgement from each of the plurality of the slave stations.

According to a third aspect of the invention there is provided a radio station for use as a master station in a multicast radio network, comprising means to transmit data simultaneously to a plurality of slave stations, means to receive in respective predetermined substantially non-overlapping time periods an acknowledgement from each of the slave stations, and means to retransmit the data if it fails to receive a positive acknowledgement from each of the plurality of slave stations.

According to a fourth aspect of the invention there is provided a radio station for use as a slave station in a multicast radio network, comprising means to receive data transmitted simultaneously to a plurality of slave stations by a master radio station, and means to transmit in a predetermined one of a plurality of substantially non-overlapping time periods an acknowledgement in response to receiving the data.

In the present specification and claims, a reference to a master station or to a slave station does not preclude a station with dual functionality that can function as either a master or slave, according to the prevailing communication requirement. Furthermore, in the present specification and claims, a reference to a radio station, master station or slave station does not preclude the station from including functionality non-essential to the invention, for example functionality relating to the application of data conveyed by the station.

In one embodiment of the invention there is a radio network comprising a master radio station and a plurality of slave radio stations. Data packets are transmitted by the master station and received by the slave stations. After the transmission of each data packet there are time periods in which the slave stations acknowledge receipt of the data. Each slave station transmits in a predetermined time period, and the time periods are substantially non-overlapping. The time period for each slave station may be pre-set, for example during installation of the slave stations or derived from the identity of the slave station. The slave stations are equipped to transmit a positive acknowledgement if the data is decoded successfully, and a negative acknowledgement if decoding is not successful.

After the acknowledgement time periods, the master will retransmit the data packet if it receives a negative acknowledgement from any of the slave stations, or if it fails to receive an acknowledgement from any of the slave stations, and will transmit the next data packet, if any, if it receives a positive acknowledgement from each slave station.

In this way, the master station receives confirmation of reception from each slave station without having to transmit the data individually to each slave station and without having to interrogate each slave station to confirm delivery.

In a second embodiment of the invention, the predetermined time periods in which the slave stations transmit an acknowledgement are assigned by the master station, for example during establishment of a network, or at the commencement of a data communication session. In this way the network can adapt to changing configurations, for example if an additional slave station moves within range of the master station.

If desired, the master station and/or each of the slave stations may be implemented in an integrated circuit.

The invention will now be described, by way of example, with reference to the accompanying drawings wherein;

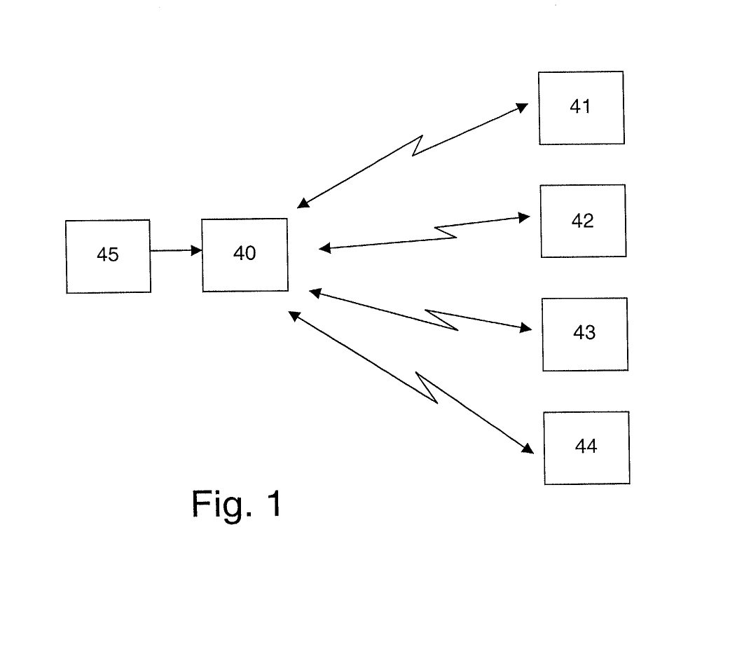

FIG. 1 is a block diagram of a system comprising a master station and four slave stations,

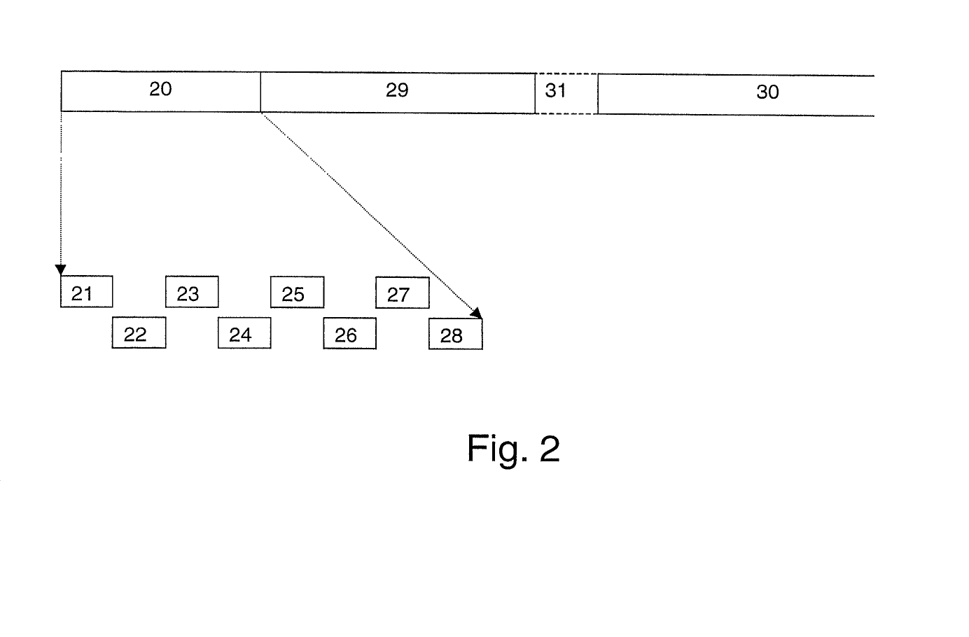

FIG. 2 is a diagram illustrating the phases of operation of the system, and

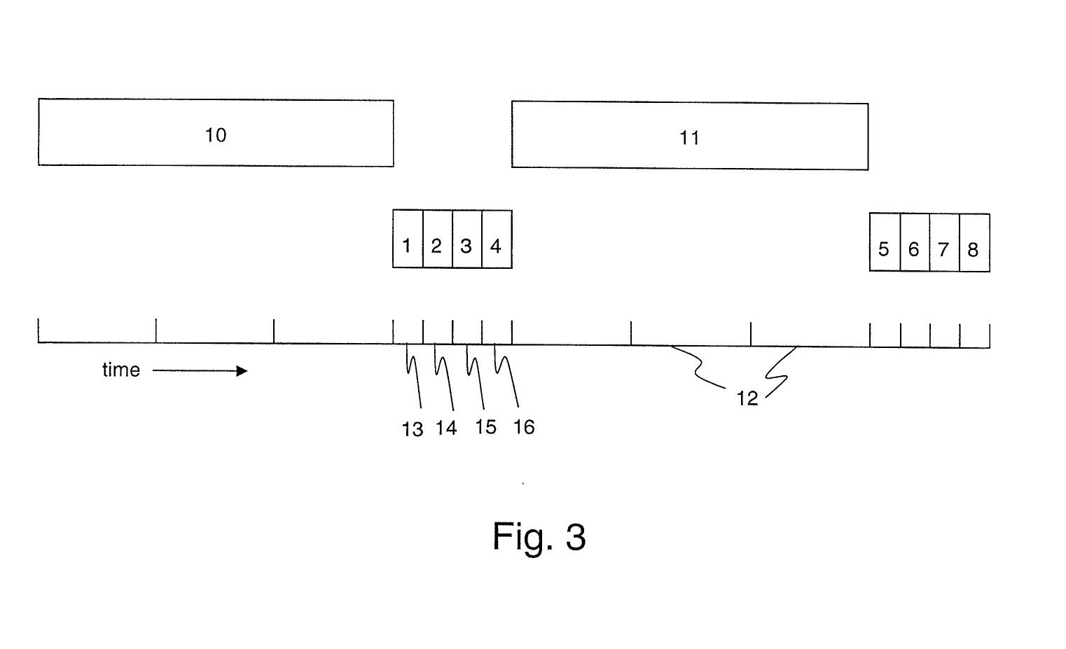

FIG. 3 is a diagram illustrating the flow of messages during a data communication session.

FIG. 1 shows a wireless network comprising a master station 40, for example a set top box, and first, second, third and fourth slave stations 41, 42, 43 and 44, for example wireless loudspeakers. The master station 40 receives an isochronous digital audio data stream from a data source 45 for distribution to the slave stations 41, 42, 43 and 44. The digital audio data stream is a multichannel mix of different audio for each wireless loudspeaker.

Referring to FIG. 2, there is an establishment phase 20 during which the wireless network is established prior to a data communication session 29. Further data communication 30 may take place after an interval 31 while the wireless network is established, as required by the application.

During the establishment phase 20, the master station transmits a paging message 21 to the first slave device 41 to confirm its availability for participating in the wireless network. The first slave station 41 transmits an acknowledgement 22 in response to the paging message. Also within the paging message, the master station assigns to the first slave station 41 a first exclusive acknowledgement time period, described below, for use during the data communication phase 29.

The master station 40 also transmits paging messages 23, 25 and 27 to the second, third and fourth slave stations 42, 43 and 44 to confirm their availability for participating in the wireless network, and to assign the slave stations respectively second, third and fourth exclusive acknowledgement time periods for use during the data communication phase 29. Each slave station 41, 42, 43 and 44 transmits an acknowledgement 22, 24, 26 and 28 in response to receiving its paging message 21, 23, 25 and 27, before the next paging message is transmitted by the master station.

FIG. 3 shows more detail of the data communication session 29. Time is divided into time slots 12 of duration 625 μs. Data is transmitted in packets that are of length one, three or five time slots. In FIG. 3 a three slot data packet 10 is illustrated. The longer packet lengths carry a higher proportion of useful data and a smaller proportion of overhead. When the system is used for carrying point-to-point data to a single slave station, a single time slot 12 of 625 μs is reserved for transmission of an acknowledgement by the single slave station. When the system is used to transmit multicast data to a wireless network containing four slave stations, a system clock in the slave station is operated at four times the rate required for point-to-point communication, thereby providing quarter slot resolution for the transmission of acknowledgements. In this way a single time slot 12 is sub-divided into four sub-slots 13, 14, 15 and 16 and four acknowledgements can be accommodated within the duration of a single time slot. The first slave station 41 transmits its acknowledgement 1 in the first sub-slot 13, the second slave station 42 transmits its acknowledgement 2 in the second sub-slot 14, the third slave station 43 transmits its acknowledgement 3 in the third sub-slot 15, and the fourth slave station 44 transmits its acknowledgement 4 in the fourth sub-slot 16. In this way multicast data communication is achieved using the same bandwidth and time duration as point-to-point communication.

If any one of the four acknowledgement messages 1, 2, 3 and 4 transmitted within one time slot is a negative acknowledgement, or if any acknowledgement fails to be successfully decoded by the master station 40, the master retransmits the data packet 11, unless the validity of the data has expired.

After retransmission of a data packet, the slave stations 41, 42, 43 and 44 transmit acknowledgements within sub-slots 5, 6, 7 and 8 according to the rules described above. If a slave station receives a duplicate data packet due to retransmission of a packet which it has previously received successfully, the slave station transmits a positive acknowledgment and discards the duplicate data packet.

If the four acknowledgement messages 1, 2, 3 and 4 transmitted within one time slot are all positive acknowledgements and are all received successfully by the master station 40, the master station proceeds to transmit a new data packet, if any. In applications requiring the transmission of a time critical stream data, new data packets may be transmitted by the master station 40 at intervals which are sufficient to permit retransmission of a data packet during the interval between new packets, without delaying the transmission of the next new data packet.

Although the embodiment has been described in relation to a wireless network comprising four slave stations which transmit within a single time slot, other numbers of slave stations may be accommodated by varying the duration of a sub-slot.

Although the embodiment is described in relation to a wireless network covering a small area with a small number of slave stations, the invention is also applicable to a wider area network and a larger number of slave stations.

Although the invention has been described in relation to a system for transmitting stream data, it can be applied to non-stream data.

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the art of multicast radio communication and which may be used instead of or in addition to features already described herein.

1. A method of operating a multicast radio system, comprising transmitting data from a master radio station simultaneously to a plurality of slave radio stations, transmitting from each of the plurality of slave radio stations, in response to receiving the data, an acknowledgement in a predetermined substantially non-overlapping time period, receiving each acknowledgement at the master station, and retransmitting the data from the master radio station if it fails to receive a positive acknowledgement from each of the plurality of slave stations.

2. A method as claimed in claim 2, in which the master radio station assigns to each of the plurality of slave radio stations the predetermined non-overlapping time period in which to transmit an acknowledgement.

3. A multicast radio system comprising a master station and a plurality of slave stations, the master station comprising means to transmit data simultaneously to the plurality of slave stations, each of the plurality of slave stations having means to transmit an acknowledgement in response to receiving the data, wherein each acknowledgement is transmitted in a predetermined one of a plurality of substantially non-overlapping time periods, and the master station further comprising means to receive the acknowledgements and means to retransmit the data if it fails to receive a positive acknowledgement from each of the plurality of the slave stations.

4. A system as claimed in claim 2, wherein the predetermined, non-overlapping time period is assigned to each slave station by the master station.

5. A radio station for use as a master station in a multicast radio network, comprising means to transmit data simultaneously to a plurality of slave stations, means to receive in respective predetermined substantially non-overlapping time periods an acknowledgement from each of the slave stations, and means to retransmit the data if it fails to receive a positive acknowledgement from each of the plurality of slave stations.

6. A radio station as claimed in claim 5, further comprising means to assign to each slave station the predetermined, non-overlapping time period in which to transmit an acknowledgement.

7. A radio station for use as a slave station in a multicast radio network, comprising means to receive data transmitted simultaneously to a plurality of slave stations by a master radio station, and means to transmit in a predetermined one of a plurality of substantially non-overlapping time periods an acknowledgement in response to receiving the data.

8. A radio station as claimed in claim 7, wherein the predetermined non-overlapping time period is assigned by the master radio station.

9. An integrated circuit comprising the radio station as claimed in claims 5 or 6.

10. An integrated circuit comprising the radio station as claimed in claims 7 or 8.

11. A radio system constructed and arranged to operate substantially as hereinbefore described with reference to and as shown in the accompanying drawings.

12. A radio station constructed and arranged to operate substantially as hereinbefore described with reference to and as shown in the accompanying drawings.

13. A method of operating a multicast radio network substantially as hereinbefore described with reference to the accompanying drawings.
